(19) United States
(12) Patent Application Publication
(10) Pub. No.: US 2006/0201915 A1
(43) Pub. Date: Sep. 14, 2006

(54) Welding process for stainless steel piping

(76) Inventors: Takeshi Obana, Hitachinaka (JP); Shoji Imanaga, Hitachi (JP); Eiji Ashida, Hitachiota (JP); Xiangjun Luo, Hitachinaka (JP); Hiroo Koide, Hitachi (JP); Mitsuaki Haneda, Mishima (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/354,910

(22) Filed: Feb. 16, 2006

(30) Foreign Application Priority Data
Mar. 9, 2005 (JP) 2005-064761

(51) Int. Cl. B23K 9/04

(52) U.S. Cl. 219/76.1

(57) ABSTRACT

The present invention has an object to reduce residual stress in a tensile direction of a weld on the inner side in contact with reactor water of austenitic stainless steel piping, and to change the residual stress into compressive stress, to reduce stress corrosive cracking. The present invention provides a welding process for stainless steel piping of laminating two types of welding wire made of different materials in a groove of austenitic stainless steel piping, including at least one of a first layer penetration welding step of performing a predetermined back bead width on the back side of the groove bottom and a tack welding step, a first lamination welding step of lamination welding of austenitic stainless steel wire from the bottom to the top of the groove, and a second lamination welding step of lamination welding of nickel-base alloy wire to a final layer at the top of the groove.

### FIELD OF THE INVENTION

The present invention relates to a process for reducing residual stress in a weld of piping, and more particularly, to a welding process suitable for reducing tensile residual stress in a weld on the inner side of austenitic stainless steel piping in contact with water to suppress stress corrosion cracking.

### BACKGROUND OF THE INVENTION

Austenitic stainless steel for use in a welded structure such as a structure, piping, and a component of a nuclear reactor in a boiling water nuclear power plant is known to produce stress corrosion cracking in a weld thereof (such as a weld metal portion and an adjacent portion affected by heat) when it is in contact with high temperature water in the nuclear reactor. The stress corrosion cracking is created under conditions in which three factors, that is, sensitization of materials, tensile residual stress, and a corrosive environment, occur together. The sensitization of materials is caused, when chromium carbide is precipitated along a grain boundary due to welding heat or the like, to form a chromium deficient layer in close proximity to the grain boundary and the chromium deficient layer close to the grain boundary is sensitized to corrosion. The tensile stress is produced by a combination of stress from external force and tensile residual stress caused in the area in contact with metal melted in welding when it is contracted at solidification. The corrosion environment occurs due to the high temperature water containing dissolved oxygen.

The stress corrosion cracking can be prevented by removing one of the above three factors. Thus, particularly, it is strongly desired to significantly reduce the tensile stress remaining in the surface of a weld exposed to the corrosion environment in contact with high temperature water or the like and in the proximity thereof and to change it into compressive stress.

Conventionally, several welding processes and welding apparatuses have been proposed in relation to a reduction in tensile residual tensile in a weld material.

For example, Patent Document 1 (JP-B-53-38246) has proposed a heat treatment process for a piping system, in which cooling water is provided within piping after welding and assembly and the exterior of the piping is heated to produce a temperature difference between the inner surface and the outer surface of the piping, and the inner surface of the piping is subjected to tensile yield and the outer surface of the piping is subjected to compressive yield.

Patent Document 2 (JP-A-2001-141629) has described a preventive and protective process and apparatus for a weld of austenitic stainless steel, which has proposed a procedure of moving a high-frequency heating coil following a linear weld to heat the weld with the high-frequency heating coil to a temperature higher than the temperature at yield stress, and a procedure of ejecting cooling water to an over heated area for quick cooling.

Patent Document 3 (JP-9-512485) has proposed a process and an apparatus for joining metal parts, in which the process includes the step of continuously supplying a weld material to the proximity of a chip at the end of an electrode traveling at a selected speed (127 cm/min or higher), the step of continuously melting the weld material in a groove with a discharge current from the chip, and the step of forming a welding bead, wherein the electrode includes a blade having a non-circular cross section joined and electrically connected to the chip, and a predetermined number of welding passes all reach a final residual stress state with compressibility without an exterior heat sink medium.

Patent Document 4 (JP-B-62-19953) has proposed a multi-pass welding process with a thin weld joint of austenitic stainless steel, in which an austenitic filler is used to weld a layer close to the deepest point of a groove and a martensitic filler is used to weld at least one outer layer adjacent to the layer.

In addition, Patent Document 5 (JP-A-11-138290) has proposed a welding process and a welding material, in which, to improve fatigue strength of a weld joint, martensitic transformation is caused in weld metal produced by welding in the process of cooling after the welding to provide the weld metal expanded at room temperature more than at the starting temperature of the martensite transformation (for example, equal to or higher than 170° C. and lower than 250° C.)

Patent Document 6 (JP-A-9-253860) has proposed a TIG welding process for high-tensile steel and TIG welding solid wire, in which martensite transformation is started at 400° C. or lower in all weld metal, and the welding is performed using solid wire formed to contain 7.5 to 12% of Ni, 0.1% or lower of C, and 2 ppm or lower of H in the total weight of the wire, at the wire feed speed set to 5 to 40 g/min.

Patent Document 1 described above requires a large-scale high-frequency heating facility as well as the work and cost for heating the exterior of the piping to high temperature while the cooling water is supplied to the interior after the completion of welding.

Patent Document 2 described above needs a mobile heating and a cooling facility. It also requires the work and cost for performing the heating to high temperature and quick cooling.

Patent Document 3 described above is designed to reduce tensile residual stress and welding distortion by the welding procedure with high thermal efficiency and the conductive self-cooling effect of a thin welded joint, but there is a strong possibility that the tensile residual stress does not reach the point where it can be changed into compressive residual stress. It uses the thin electrode formed in the non-circular shape (the non-circular cross section) different from an inexpensive tungsten electrode rod having a circular cross section, so that the thin electrode involves high manufacturing costs and replacement costs since the end of the electrode is consumed after it is inserted into the groove to perform arc welding. The wire (filler material) supplied into the groove and melted is austenitic stainless steel wire of the same composition as that of the joint to be welded. The wire made of a different material is not used.

Patent Document 4 described above uses the austenitic stainless steel wire and the martensite wire for the different areas in welding, but the tensile stress still remains and can not be changed into compressive stress. The martensite wire is used only for the weld at an immediate layer in the groove and is not used for the welded at the final layer on the top of the groove. In addition, the welded joint has a wide angle, and when the welded joint having a large thickness is welded, the cross section of the groove to be welded and the width of the groove are increased, thereby making it difficult to perform welding by laminating each layer with one pass. Thus, it needs multi-pass welding with each layer welded by a number of passes, and the tensile residual stress and compressive deformation are likely to increase. The welding process is unknown, but when assumed from the embodiment, an arc welding process using welding wire (filler) as an electrode may be applied, rather than an arc welding process using non-consumable tungsten as an electrode.

Patent Document 5 described above mainly employs a weld structure of a low-alloy steel material (such as a high-tensile steel material) for welding and is not applicable to welding of austenitic stainless steel made of a different material. The tensile residual stress produced by welding is reduced on the welded surface of a fillet welded joint, a T joint, and a cross joint, or the surface of a double-sided weld of an X welded joint, and is not on the back side of a single-sided weld as in a thin welded joint having a different joint shape or penetration shape, in which such reduced stress is required.

Patent Document 6 described above is considered as effective in preventing weld cracking of high-tensile steel, but is not applicable to welding of stainless steel made of a different material.

Besides them, several welding processes have been proposed which utilize welding wire for causing martensite transformation, but they mainly support welding of high-tensile steel materials rather than welding of austenitic stainless steel materials. As in Patent Document 6 described above, the tensile residual stress produced by welding is reduced on the surface of a weld, and is not on the back side of a single-sided weld as in a thin welded joint having a different joint shape or penetration shape, in which such reduced stress is required.

### BRIEF SUMMARY OF THE INVENTION

The present invention has been made in view of the foregoing and it is an object thereof to provide a welding process for stainless steel piping which suppresses stress corrosion cracking by reducing residual stress in a tensile direction at a weld on the inner side of austenitic stainless steel piping in contact with reactor water in a boiling water reactor and changing the residual stress into compressive stress.

Other objects, features and advantages of the invention will become apparent from the following description of the embodiments of the invention taken in conjunction with the accompanying drawings.

### BRIEF DESCRIPTION OF THE DRAWINGS

FIGS. 1(1) to (4) are welding cross sections of an embodiment showing the outline of welding in a welding process for stainless steel piping according to the present invention.

FIGS. 2(1) and (2) are welding cross sections of another embodiment showing the outline of welding in the welding process for stainless steel piping according to the present invention.

FIG. 3 is a flow chart for explaining an embodiment showing the outline of a welding procedure in the welding process for stainless steel piping according to the present invention.

FIG. 4 is a graph for schematically showing the relationship between temperature and average linear expansion coefficient in nickel-base alloy wire and austenitic stainless steel wire (or a welded joint material made of the same material as the wire) used in multi-pass welding shown in FIGS. 1 and 2.

FIGS. 5(1) and (2) schematically show a contraction amount in a circumferential direction of piping at a cross section of a weld formed by lamination welding using austenitic stainless steel wire and a contraction amount in a circumferential direction of piping at a cross section of a weld formed by lamination welding using a combination of austenitic stainless steel wire and nickel-base alloy wire, respectively.

FIG. 6 is a schematic diagram showing an embodiment of a welding apparatus according to the welding process for stainless steel piping according to the present invention.

### DESCRIPTION OF REFERENCE NUMERALS

1, 2 WELDED JOINT MEMBER
1a, 2a GROOVE FRONT
1b, 2b GROOVE BACK
3 GROOVE INTERIOR
4 WELDING VEHICLE
5 WIRE
6 ELECTRODE
7 WELDING TORCH
8 TIG WELDING POWER SUPPLY
9a WELDING CONTROLLER
9b OPERATION PENDANT
10 ARC
11 WIRE SUPPLY MOTOR
15 BACK BEAD
16 MOLTEN POOL ON BACK SIDE
18 MOLTEN POOL ON FRONT SIDE
19 INSERT MATERIAL
21 BEAD CROSS SECTION OF FIRST LAYER PENETRATION WELDING
26 REMAINING WELDING PORTION
30 BEAD CROSS SECTION OF FINAL LAYER
32 ILLUMINATION MEANS
33 SHIELD GAS
35 FIRST CAMERA
36 CAMERA CONTROLLER
37 FIRST VIDEO MONITOR
39 MOLTEN POOL ON FRONT SIDE
41 LAMINATION WELDING (FIRST LAMINATION WELDING STEP)
42 LAMINATION WELDING (SECOND LAMINATION WELDING STEP)
51 MANUFACTURING STEP OF GROOVE SHAPE
52 WELDING PREPARATORY STEP
56 AUSTENITIC STAINLESS STEEL WIRE
57 NICKEL-BASE ALLOY WIRE
411 FIRST WELD METAL
422 SECOND WELD METAL
B BACK BEAD WIDTH
Hb CUMULATIVE LAMINATION BEAD HEIGHT
H REMAINING GROOVE DEPTH
T THICKNESS
W GROOVE BOTTOM WIDTH
F ROOT FACE
θ SIDE GROOVE WALL ANGLE

### DETAILED DESCRIPTION OF THE INVENTION

To achieve the abovementioned object, according to an aspect, the present invention provides a welding process for stainless steel piping of performing lamination welding from the bottom to the top of a groove using two types of a filler made of different materials, the groove being formed between austenitic stainless steel pipes by mutually butting each groove of the austenitic stainless steel pipes, thereby reducing tensile residual stress in a weld on the back side of the bottom of the groove, wherein the welding process is characterized by using a first weld metal formed by supplying and melting an austenitic stainless steel filler made of the same material as that of the pipes at an ark welding portion in the groove to perform lamination welding of the filler from the back to a predetermined cumulative lamination bead height in the groove after the first layer penetration welding is performed to form a predetermined back bead width on the back at the bottom of the groove, and a second weld metal formed by supplying and melting a nickel-base alloy filler at the ark welding portion in the groove to perform lamination welding of the filler from the remaining portion in the groove in contact with the bead surface of the first weld metal to a final layer at the top of the groove.

According to another aspect, the present invention provides a welding process for stainless steel piping of performing pulsed arc welding with a non-consumable electrode by using two types of welding wire made of different materials from the bottom to the top of a groove, the groove being formed between austenitic stainless steel pipes by mutually butting each groove of the austenitic stainless steel pipes, thereby reducing tensile residual stress in a weld on the back side of the bottom of the groove, wherein the welding process is characterized by including a manufacturing step of forming the groove of the pipes to be welded into a shape having dimensions in a predetermined range, at least one of a first layer penetration welding of forming a back bead having a predetermined width on the back at the bottom of the groove or tack welding step and the first layer penetration welding after the completion of welding preparation, a first lamination welding step of supplying and melting austenitic stainless steel wire made of the same material as the pipes at an arc welding portion in the groove to perform lamination welding from the back to a predetermined cumulative lamination bead height of the groove, and a second lamination welding step of supplying nickel-base alloy wire different from the austenitic stainless steel wire at the arc welding portion to perform lamination welding from the remaining portion in the groove to a final layer at the top of the groove after the first lamination welding step.

The welding process for stainless steel piping according to the present invention is characterized in that the second weld metal made of the nickel-base alloy laminated in the second lamination welding step has a linear expansion coefficient smaller than that of the first weld metal.

As compared with the first weld metal formed by the melting and lamination of the austenitic stainless steel wire made of the same material as the pipes, the second weld metal formed in the outer surface direction of the pipes is formed by the melting and lamination of the nickel-base alloy wire having a smaller linear expansion coefficient, so that the second weld metal involves less contraction in the process of solidification after the melting in the each metal.

In the formation of the first weld metal by the lamination welding of the austenitic stainless steel wire, the first weld metal is solidified and contracted after the melting, and thus the piping around the wire is affected to produce welding deformation, specifically, a phenomenon of contraction of the piping in the circumferential direction. This phenomenon which causes the contraction of the piping in the circumferential direction by the welding is called “tawarajime contraction”. If the austenitic stainless steel wire is used to perform lamination welding to the final layer at the top of the groove of the piping, that is, if the first weld metal is used for all the welds in the groove, then the contraction in the circumferential direction of the piping is increased to produce the large bending deformation in the tensile direction at the weld on the inner side of the piping, and stress in the tensile direction remains.

To address this, the nickel-base alloy wire is laminated and welded to form the second weld metal from the remaining weld in the groove to the final layer at the top of the groove after the formation of the first weld metal. Due to the smaller linear expansion coefficient than that of the austenitic stainless steel wire forming the first weld metal, the contraction in the circumferential direction of the piping (the tawarajime contraction) can be suppressed to reduce the tensile stress remaining at the back of the weld on the bottom of the groove or the proximity thereof, or to change the tensile stress into compressive stress. Simultaneously, the tensile stress remaining at the front of the weld in the final layer can be reduced significantly than in the related arts.

For the welding wire used in forming the second weld metal of the nickel-base alloy, YNiCr-3 equivalent wire and YNiCrMo-3 equivalent wire specified by JIS Z3334 are preferable. Especially, the YNiCr-3 equivalent wire is used as welding wire when a shroud made of austenitic stainless steel which is a structure in the boiling water reactor is welded to a shroud support made of nickel-base alloy, and is preferable since it has already been used as welding wire for welding austenitic stainless steel in the boiling water nuclear power plant.

The welding process for stainless steel piping according to the present invention is characterized by including the second weld metal of the nickel-base alloy formed by lamination welding with one pass for each layer in the first lamination welding step, and lamination welding with one pass for each layer in the second lamination welding step, or lamination welding with two passes for each layer in the respective parts of the grove on the left and right in the process of the lamination with one pass for each layer, or lamination welding with three or more passes for the final layer.

The welding process for stainless steel piping according to the present invention is characterized in that the shape of groove of the pipe is specified a groove width at the bottom of the groove or a groove width including the width of an insert material inserted into the center of the groove bottom as 4 mm or larger at minimum to 8 mm or smaller at maximum, and is specified a side groove wall angle to the top of the groove as 10 degrees or less.

Specifically, the groove has a thin shape so as to make the cross section thereof small, thereby reducing the necessary amount of the welding wire. As a result, the amount of the solidified and contracted weld metal can be reduced. This can reduce welding deformation due to the contraction at solidification of the weld metal.

In addition, the thin groove enables the lamination welding with one pass for each layer and reduce the heat input amount for each welding pass, so that contraction deformation due to welding heat can be suppressed. Furthermore, the number of the steps in the welding can be reduced.

Even when the groove is formed such that one layer-one pass welding does not cause easily the melting of the groove or welding wire, or under the same or slightly lower heat input, the one layer-two pass welding can melt both walls having the groove width to provide favorable welding results to the final layer at the top of the groove. In addition, the increased welding passes in the final layer to three or more can increase the cumulative bead width in the final layer.

Also, the welding process for stainless steel piping according to the present invention is characterized in that the cumulative lamination bead height is specified in a range from ⅕ or larger to ⅘ or smaller of the thickness of the pipe, and the lamination welding is performed by supplying and melting the austenitic stainless steel wire made of the same material as the pipes at the arc welding portion in the groove to the height of the specified cumulative lamination bead height.

Specifically, the particular back bead width as a target (for example, the proper range of the back bead width is specified from 4 to 7 mm, and preferably 4 to 6 mm) can be formed, and the weld metal with the austenitic stainless steel wire made of the same material as the pipes can fill the grove to the inner side exposed to a corrosive environment in contact with high-temperature water or the like, or the back of the weld on the bottom side, and from the back of the weld to the predetermined height.

According to another aspect, the present invention provides primary cooling water piping of a boiling water reactor including components such as a reactor core spray nozzle, a feedwater nozzle, a safe end, and a recirculation piping, the components being made of austenitic stainless steel, wherein a weld of the primary cooling water piping is formed by pulsed arc welding with a non-consumable electrode using two types of welding wire made of different materials to perform lamination from the bottom to the top of a groove, the groove being formed between austenitic stainless steel pipes by mutually butting each groove of the austenitic stainless steel pipes, wherein the primary cooling water piping is characterized by including a first weld metal provided by supplying and melting austenitic stainless steel wire made of the same material as the primary cooling water piping at an arc welding portion in the groove to perform lamination welding from the back of the groove to a predetermined cumulative lamination bead height, and second weld metal portion provided by supplying and melting nickel-base alloy wire at the arc welding portion in the groove to perform lamination welding from the remaining portion in the grove in contact with the bead surface of the first weld metal to a final layer at the top of the groove.

In addition, the primary cooling water piping is characterized in that the proximity of the weld on the inner side in contact with the water has a residual stress of 100 MPa or smaller in a tensile direction.

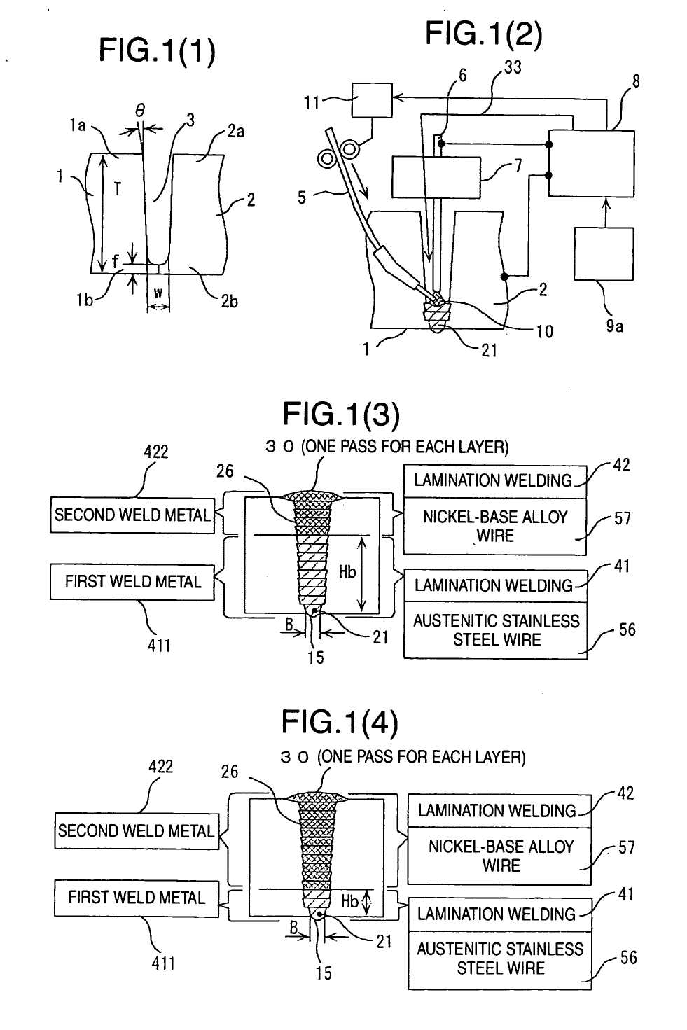

The present invention will hereinafter be described specifically with reference to Embodiments shown in FIGS. 1 to 6.

### Embodiment 1

FIGS. 1(1) to (4) show Embodiment 1 and illustrate the outline of a welding process for austenitic stainless steel piping according to the present invention. FIG. 1(1) shows a cross section of a groove joint member of the piping before welding, FIG. 1(2) is a cross section of the general structure of a welding apparatus during welding, FIG. 1(3) is a cross section in which austenitic stainless steel wire is melted in a groove for lamination welding to a height Hb corresponding to approximately ⅗ of a thickness T from the bottom of the groove, and then the wire is replaced with nickel-base alloy wire for lamination welding to the final layer at the top of the groove from a remaining weld 26, and FIG. 1(4) is a cross section as in FIG. 1(3) in which austenitic stainless steel wire is melted in the groove for lamination welding to a smaller height Hb corresponding to approximately ¼ of the thickness T, and then the wire is replaced with nickel-base alloy wire for lamination welding to the final layer at the top of the groove from the deep point at the height Hb.

Preferably, the cumulative bead height Hb to which the bead should be laminated from the back of the groove is specified in a range from ⅕ or higher to ⅘ or lower of the thickness T of the weld joint, and the remaining groove height H to which the groove should be maintained from the top of the groove is specified in a range from ⅘ or lower and ⅕ or higher of the thickness T (which means that H=T−Hb).

Hb, which is extremely smaller than ⅕ of the thickness T, is not preferable since it may impair the anticorrosion and the prevention of progression of corrosion at the back of the weld exposed to a corrosive environment. The minimum value of the laminated bead height Hb varies with the thickness T, but an austenitic stainless steel wire 56 is preferably used to perform welding at least to the welding bead height of a second layer.

On the other hand, Hb, which is extremely larger than ⅘ of the thickness T, is not preferable since the remaining portion, in which a nickel-base alloy wire 57 subsequently replacing the wire 56 should be used for lamination welding to the final layer, is too small to provide a sufficient effect of reducing the tensile stress remaining at the back of the weld and the proximity thereof by taking advantage of the difference in linear expansion coefficient.

As shown in FIG. 1(1), welded joint members 1 and 2 are part of a thin welded joint formed by facing pipes which requires multi-pass welding involving the formation of back bead 15 on the side of groove backs 1b and 2b and the lamination to the top of the groove on the side of groove fronts 1a and 2a. Specifically, the thin weld joint is included in austenitic stainless steel piping for use in a boiling water nuclear power plant, and it is important to reduce tensile stress remaining in the weld on the back side (i.e. back bead 15 and the proximity thereof) by performing the multi-pass welding and to change it into compressive stress.

As shown in FIG. 1(2), arc welding is performed by a TIG welding power supply 8 supplying power between the end of a non-consumable electrode 6 provided for welding torch 7 (TIG torch) and the welded joint members 1, 2 to produce arc 10 in the groove and extending and melting wire 5 at the arc weld point in the groove to perform lamination welding of each layer with one pass.

TIG welding power supply 8 can be used to perform pulsed arc welding. It can be formed to arbitrarily output each condition value such as a peak current, a base current, and an arc voltage necessary for the power supply in the pulsed arc welding and to arbitrarily change a pulse frequency (for example, from 1 Hz to 500 Hz at maximum). A welding controller 9a controls with instructions the travel of welding vehicle 4 (not shown) carrying welding torch 7 and wire 5, controls with instructions the output from TIG welding power supply 8, controls with instructions the horizontal position and vertical position of welding torch 7 (electrode 6) as required, and adjusts the supply of wire 5 to the weld at arc 10 and the horizontal position and vertical position of the wire 5 as required.

For wire 5, austenitic stainless steel wire (for example, commercially available wire of SUS 304 type, SUS 308 type, or SUS 316 type having an outer diameter from 0.8 to 1.2 mm) made of same material as that of the welded joint members 1 and 2 (for example, of SUS 304 type or SUS 316 type) is used.

For shield gas 33 flowed to the weld at arc 10 in groove 3, an inert pure argon gas, or a gas containing several percents of hydrogen mixed into argon, or a mixed gas containing several tens of percents of helium in argon can be used. The use of the mixed gases can enhance energy density or arc convergence as compared with the pure argon gas, improve the molten state and penetration, and increase the welding speed.

The non-consumable electrode 6 is a round bar made of tungsten containing lanthanum oxide (La₂O₃) as a high-melting point material, tungsten containing yttrium oxide (Y₂O₃), and tungsten containing thorium oxide (ThO₂), and a round electrode having a diameter insertable into the groove can be used. For example, the electrode for use can have a small diameter of 1.6 mm or 2.4 mm (only the end of the electrode is processed into a conical shape and then is used) to stably hold arc 10 at the bottom of the groove where melting should be realized without disturbing arc 10 produced between the end of the small-diameter electrode and the bottom of the groove in the direction closer to the wall in an atmosphere in which the shield gas is flowed. The electrode 6 can be available at low cost, be processed only at its end of the round bar into the conical shape by a simple electrode polisher, and be provided with excellent usability such as easy reprocessing at the electrode wear and easy mounting and removal on and from the welding torch. It is possible to use, instead of the small-diameter electrode 6, a non-consumable flat electrode formed by shaping a large-diameter electrode to have a lower flat portion with a width smaller than the groove width w. The flat electrode requires the manufacturing cost to form the flat shape in the lower portion of the large-diameter round electrode. However, similarly to the abovementioned small-diameter electrode 6, only the end of the electrode can be processed into a conical shape easily by a simple electrode polisher and it is easily mounted on and removed from the welding torch.

In Embodiment 1, the side groove wall angle θ is set to 10° or smaller. A root face f at the groove bottom can be formed in a range from approximately 1 to 2.5 mm, preferably at approximately 1.5 mm, to achieve easy melting to the back side. An insert material 19, not shown, can be inserted into the center of the groove bottom to reduce the influence of a difference in height or a gap which tends to occur at the matching portions in the groove bottom, and particularly, when the first layer penetration welding is performed, an almost uniform back bead width B can be provided in convex shape without concave.

In FIG. 1(1), the thin groove shape is formed to have the groove width w at the groove bottom of 4 mm or larger at minimum and 8 mm or smaller at maximum, and the side grove wall angle θ of 10° or smaller to the top of the groove, so that the groove cross section where welding should be performed can be reduced, and thus the necessary amount of wire and the number of man-hours of the welding can be reduced. While a welded joint with an increased side groove wall angle θ can be welded with multi-pass, the groove cross section A for welding is widened to increase the number of welding passes, the welding time, the cumulative heat input amount, and the contractive deformation. The grove width w at the groove bottom less than 4 mm is too narrow. This is because the gap between the outer surface of the electrode 6 to be inserted into the groove and the wall surface in the groove 3 is narrow and the whole groove width is contracted due to heat shrinkage from the first layer welding and the subsequent welding, so that the electrode 6 easily comes into contact with the groove wall surface and arc fluctuations tend to occur, and thus the lamination welding to the top of the groove is difficult to achieve. On the other hand, the groove width w at the groove bottom larger than 8 mm is too large. This is because the increased cross section of the groove increases the number of welding passes, the necessary amount of wire, and the number of man-hours of the welding.

The insert material 19 may be inserted into the center of the groove bottom. In this case, the preferable range of the groove width is as the same as that described above.

### Embodiment 2

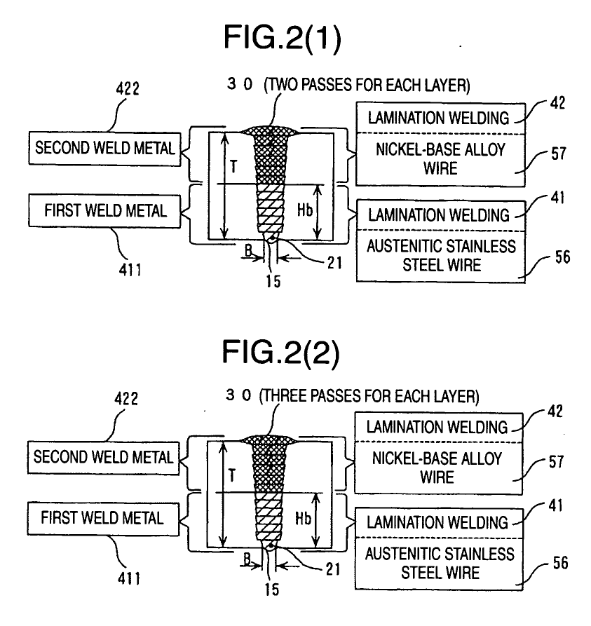

FIGS. 2(1) and (2) are cross sections in which lamination welding is performed with an increased number of welding passes in Embodiment 2 illustrating a welding process for austenitic stainless steel piping according to the present invention.

Even when a groove width is so large that welding is not easily achieved by the one layer-one pass welding, or under the same or slightly lower heat input for arc, the one layer-two pass welding can melt both walls having that groove width to provide favorable welding results to the final layer at the top of the groove.

In addition, the welding passes of the final layer can be increased to three or more to further increase the cumulative bead width of the final layer.

A second welding metal 422 has a linear expansion coefficient smaller than that of a first welding metal 411 and involves less contraction in the process of solidification after the melting, so that the contraction in the circumferential direction (the tawarajime contraction) of piping is reduced as compared with the case where the first welding metal 411 is used for all the welds in a groove 3. As a result, the tensile stress remaining at the back of the weld on the groove bottom and the proximity thereof can be reduced, and also, compressive stress can be provided. Simultaneously, the tensile stress remaining at the front of the weld in the final layer and the proximity thereof can be significantly reduced.

### Embodiment 3

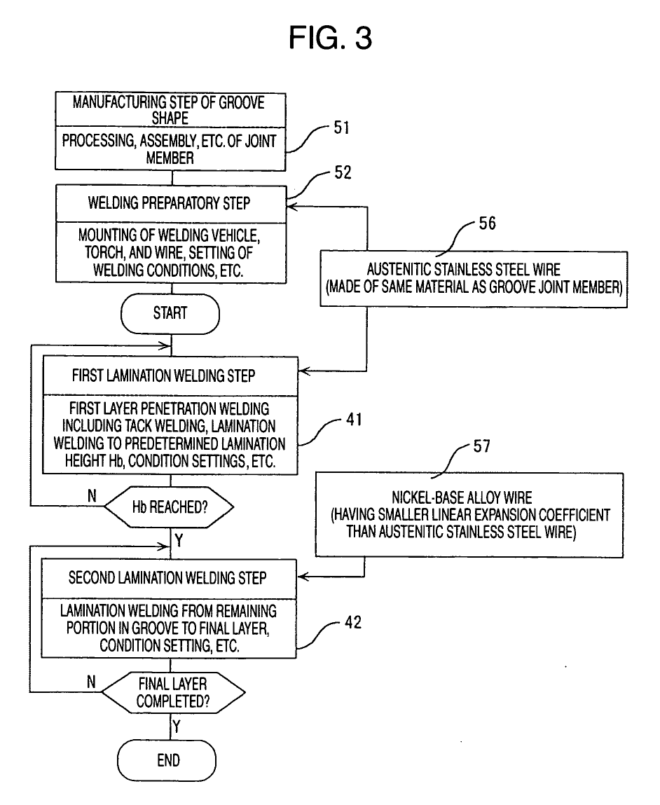

FIG. 3 is a flow chart for explaining an embodiment of the welding process for austenitic stainless steel piping.

At first step 51 of manufacturing a groove shape before welding, the joint members to be welded are machined to predetermined dimensions, they are carried to a location for welding, the joint members after processing and parts are assembled, and the like. For example, at the manufacturing step 51, the groove width, the groove wall angle and the like are adjusted.

Next, at a welding preparatory step 52, welding vehicle 4, welding torch 7, wire 5 and the like are set up. TIG welding power supply 8 and welding controller 9a are activated. Welding operation is prepared and the welding conditions are set. For wire 5, austenitic stainless steel wire 56 made of the same material as that of the welding joint is preferably prepared.

Then, at a first lamination welding step 41, which includes first layer penetration welding for forming a predetermined back bead width B on the back of the groove bottom or tack welding and the first layer penetration welding, welding operation is performed by supplying the austenitic stainless steel wire 56 made of the same material as that of the welded joint members 1, 2 to the spot of arc welding in the groove and melting it for lamination welding from groove backs 1b, 2b to the predetermined cumulative lamination bead height Hb. The first lamination welding step 41 fills the weld metal of the austenitic stainless steel made of the same material as that of weld joint members 1, 2 from the back of the groove on the inner side or the bottom side of the piping exposed to the corrosive environment in contact with high-temperature water or the like to the predetermined height in the groove to reliably provide the first weld metal 411.

The austenitic stainless steel wire 56 can be supplied and melted at the spot of arc welding in the groove for lamination welding with one pass for each layer to predict the remaining groove height H where welding should be performed subsequently, the number of welding passes, and the number of layers.

In the first layer penetration welding initially performed, the back bead width B to be formed is specified in a proper range from 4 to 7 mm, preferably from 4 to 6 mm, and the first layer condition of heat input for arc to allow melting to the groove backs 1b, 2b is output to form the back bead width B falling within the specified range. For example, at least one of the condition factors including the peak current, the base current, the peak voltage, the average arc voltage, the arc length, and the wire feed speed in the pulsed arc welding is adjusted or controlled to form the molten pool width on the back or the back bead width B near the molten pool in the abovementioned specified proper range. This eliminates the influence of individual differences of welders operating the welding machine when they are changed. The target back bead width B can be formed in the proper range of the specific values (for example, in the range from 4 to 6 mm) to provide the almost uniform back bead width B in convex shape without concave.

The first layer penetration welding may be performed after the tack welding for melting at a shallow groove bottom without using wire. In the second layer welding after the completion of the first layer penetration welding, the austenitic stainless steel wire 56 is used, and the welding condition is changed to a reduced heat input condition in which at least the back bead 15 formed at the first layer welding is not remelted (for example, the heat input condition equal to ½ to ⅔ of the first layer welding condition) to perform pulsed arc welding with the non-consumable electrode. The welding performed in this manner with the reduced heat input in the second layer welding can prevent remelting of the back bead 15 and increase the bead height laminated on the front.

In the first lamination welding step, the pulsed arc welding with the non-consumable electrode or the direct-current arc welding is performed to achieve the lamination welding (41) with one pass for each layer in a plurality of proper lamination conditions for the welding passes different from at least the first layer welding condition and the second layer welding condition (for example, a low heat input condition from 4 to 12 kJ/cm or an arc condition with an average welding current from approximately 120 to 220 A). Alternatively, the pulsed arc welding with the non-consumable electrode may be performed to perform lamination welding 41 by setting an almost constant proper welding condition (for example, a low heat input condition specified to approximately 4 kJ/cm or approximately 6 kJ/cm or approximately 8 kJ/cm or approximately 10 kJ/cm or approximately 12 kJ/cm).

The supply of wire 5 is set to a wire amount which can be melted in the welding heat input condition, for example, such that the bead height to be formed falls in a range from 0.5 to 2.0 mm.

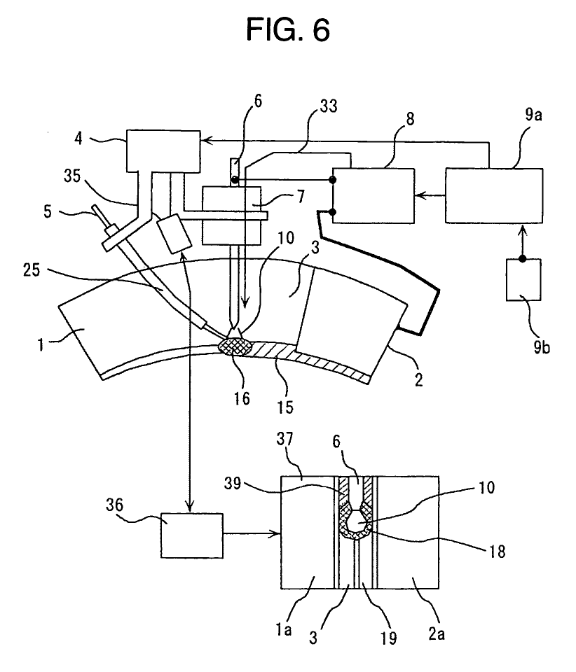

During the welding, the position of the electrode 6, or the position of the electrode 6 and the position of the wire 5 may be adjusted or controlled on the basis of the monitoring result of the welding state on the front side displayed on the screen of a first video monitor 37, later described in FIG. 6.

Next, at a second lamination welding step 42, the nickel-base alloy wire 57 is supplied to and melted at the spot of arc welding in the groove. The lamination welding is performed with one pass for each layer from remaining weld 26 in the groove to the final layer at the top of the groove, or the lamination welding is performed with two passes for each layer in the respective parts of the grove on the left and right as required in the process of the lamination with one pass for each layer as shown in FIGS. 2(1) and (2), or the lamination welding is performed with three or more passes for the final layer. Thus, as described above, the weld metal of the nickel-base alloy wire 57 can be filled in the groove from the remaining weld 26 to the final layer at the top of the groove.

Particularly, it is preferable to set one or more specific values in a range from 1 Hz to 500 Hz, preferably to 150 Hz, as a pulse frequency including alternate repetition of a high peak current and a low base current to be output for each welding pass or each welding layer in the first lamination welding step and the second lamination welding step. It is also preferable to set a plurality of specific values used in at least one of the first layer penetration welding and the tack welding, the first lamination welding step excluding the first layer penetration welding, and the second lamination welding step, respectively. The pulsed arc at the pulse frequency including the specified value is output for each welding pass or each welding layer to perform the lamination welding, thereby making it possible to increase the arc power and directivity and promote the melting and penetration depth in both walls in the groove and the groove bottom. In addition, favorable multi-pass welding results can be provided from the bottom to the top of the groove.

When the pulse frequency during the pulsed arc welding is at the lowest 1 Hz (pulse cycle: 1 s), the ripple shape (waves as shells) of the welding bead tends to be rough to approximately 1.5 mm or larger at a welding speed of 90 mm/min or higher, for example. On the other hand, at the high pulse frequency of approximately 300 Hz or approximately 500 Hz, the pulse cycle is extremely short. When the feeder cable needs to be extended (for example, extended ten times i.e. 100 mm or longer), an increased reactor associated with the extended feeder cable changes the rectangular peak current waveform into a trapezoidal or triangular shape, so that the peak current value is preferably corrected to be slightly higher in advance. If the pulse frequency is reduced to approximately 150 Hz or lower, the peak current waveform of almost rectangular shape can be output even when the feeder cable is extended to 100 m, for example. In addition, annoying high-pitched sounds can be significantly reduced.

### Embodiment 4

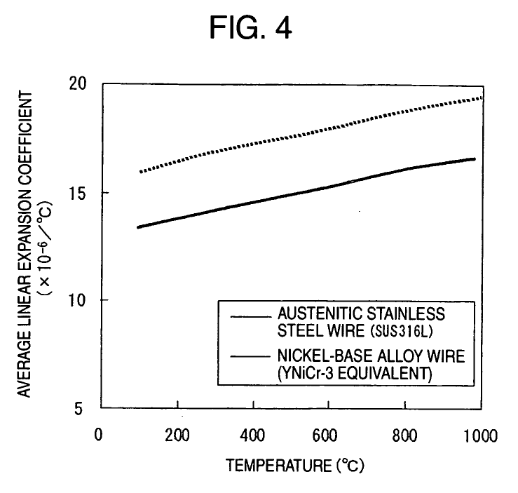

FIG. 4 is a graph for schematically explaining the relationship between the temperature and average linear expansion coefficient in SUS 316L wire (or the welded joint material made of the same material as the wire) which is austenitic stainless steel wire and JIS Z3334 YNiCr-3 equivalent wire which is nickel-base alloy wire used in the welding process for austenitic stainless steel piping shown in FIGS. 1, 2, and 3.

As shown in FIG. 4, as compared with the austenitic stainless steel wire (or the weld joint material made of the austenitic stainless steel wire) shown by a dotted line, the nickel-base alloy wire shown by a solid line represents smaller values of the liner expansion coefficient in the entire temperature range up to 1000° C. In other words, at the solidification after the melting in the lamination welding, the nickel-base alloy wire involves less contraction.

Thus, the YNiCr-3 equivalent wire and YNiCrMo-3 equivalent wire specified by JIS Z3334 are preferable as the nickel-base alloy wire for welding used to form the second weld metal 422. Especially, the YNiCr-3 equivalent wire is used as welding wire in welding a shroud made of austenitic stainless steel which is a structure in the boiling water reactor to a shroud support made of nickel-base alloy, and is preferable since it has already been used as welding wire in welding to austenitic stainless steel in the boiling water nuclear power plant.

### Embodiment 5

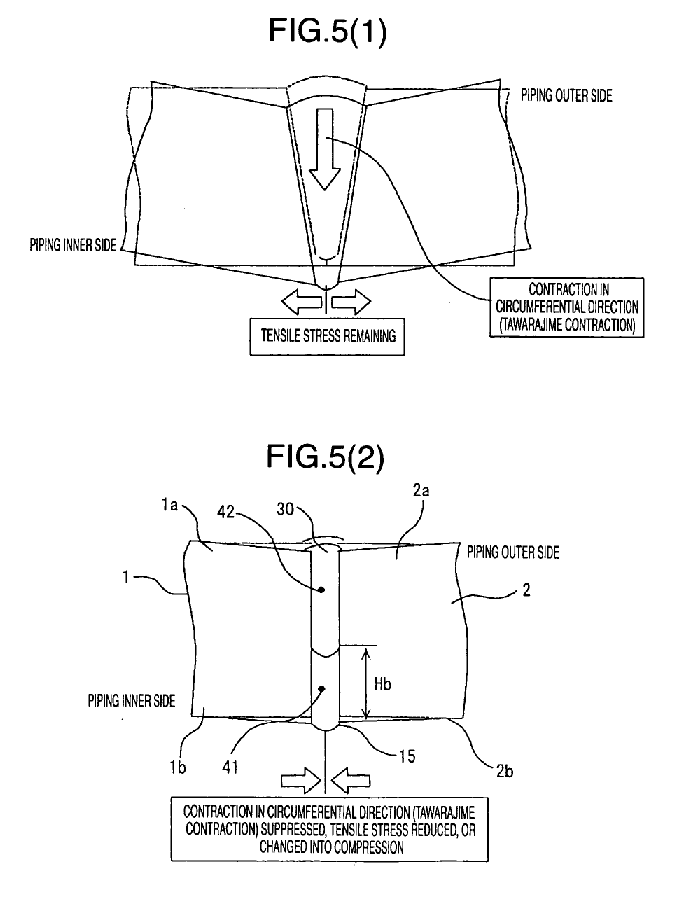

FIG. 5(1) is an explanatory diagram schematically showing that, when austenitic stainless steel wire is used for all the lamination welding in a groove, the contraction in the circumferential direction of piping (the tawarajime contraction) is increased, large bending deformation occurs in the tensile direction at the weld on the inner side of the piping, and the stress in the tensile direction remains.

FIG. 5(2) is an explanatory diagram schematically showing that, when austenitic stainless steel wire is used for lamination welding of a first weld metal from the bottom of a groove to a specific cumulative lamination bead height and nickel-base alloy wire is used for lamination welding of a second weld metal from the remaining weld 26 in the groove to the final layer at the groove top, the contraction at solidification of the second weld metal is smaller than the contraction at solidification of the first weld metal due to the material of the piping and a smaller linear expansion coefficient of the second weld metal than the austenitic stainless steel forming the first weld metal, so that the contraction in the circumferential direction of the piping (the tawarajime contraction) is restrained, the tensile stress remaining at the back of the weld on the groove bottom and the proximity thereof can be reduced, and compressive stress is provided.

In the welding process for austenitic stainless steel piping according to the present invention, the lamination welding is performed by separately using the two types of wire having the different contraction curves for temperature changes shown in FIG. 4. Specifically, as shown in FIGS. 5(1) and (2), the austenitic stainless steel wire is used for lamination welding (41) on the groove bottom side, and then the nickel-base alloy wire having a smaller linear expansion coefficient is used for lamination welding (42) from the remaining portion in the groove to the final layer at the groove top. With the two types of wire separately used in this manner for lamination welding (41, 42), since the nickel-base alloy wire has a smaller linear expansion coefficient than the austenitic stainless steel which forms the piping and the first weld metal 411 as described above, the second weld metal 422 involves contraction at solidification less than that of the first weld metal 411, the contraction in the circumferential direction of piping (the tawarajime contraction) is restrained, the tensile stress remaining at the back of the weld on the groove bottom side and the proximity thereof can be reduced, and compressive stress is provided.

### Embodiment 6

FIG. 6 is a schematic diagram showing the structure of an embodiment of a welding apparatus according to the welding process of the present invention. Joint members 1, 2 to be welded are part of piping made of thick austenitic stainless steel and require first layer penetration welding including the formation of a back bead 15 (complete penetration) on the back side at the groove bottom, multi-pass welding to the groove top, and a reduction in residual stress at the weld back.

Embodiment shown in FIG. 6 shows the first layer penetration welding in which both of a non-consumable electrode 6 put on a welding torch 7 (TIG torch) mounted on welding vehicle 4 running on rails and wire holder 25 guiding wire 5 are inserted into groove 3 and wire 5 is supplied into an arc 10 and a molten pool produced in an atmosphere into which shield gas 33 is flowed, thereby forming back bead 15 on the back side at the groove bottom.

For shield gas 33 flowed into the weld in the groove 3, an inert pure argon gas, or a mixed gas containing H₂ at 3 to 7% in argon, or a mixed gas containing He at 50 to 80% in argon can be used. The use of the mixed gases can enhance energy density or arc convergence as compared with the pure argon gas, improve the molten state and penetration, and increase the welding speed.

TIG welding power supply 8 is connected between the electrode 6 at the end of welding torch 7 and the joint members 1 and 2. It can arbitrarily output each condition value such as a peak current, a base current, and an arc voltage necessary for the power supply in pulsed arc welding and arbitrarily change a pulse frequency (for example, 1 Hz to 500 Hz at maximum).

Welding controller 9a controls with instructions the travel of welding vehicle 4 carrying welding torch 7 and wire 5, controls with instructions the output from TIG welding power supply 8, controls with instructions the horizontal position and vertical position of welding torch 7 (the electrode 6) as required, and adjusts the supply of the wire 5 to the end of electrode 6, and the horizontal position and vertical position of wire 5 as required. An operation pendant 9b is connected to welding controller 9a and contains a welding condition adjusting means and a torch position and wire position adjusting means. The welding condition adjusting means contained in operation pendant 9b can set various condition values such as the peak current and the peak current time in the pulsed arc welding, the base current and the base current time, or the pulse frequency and the peak current time ratio, the peak voltage or the base voltage or the average arc voltage used in controlling the height of the electrode (AVC control), the peak wire feed and the base wire feed, the welding speed or the running speed corresponding to the welding speed, or adjust these condition values by interruption during welding operation. The torch position and wire position adjusting means can adjust the displacement of welding torch 7 or the displacement of wire 5.

The welding condition adjusting means contained in the operation pendant 9b has the function capable of setting, storing, and reproducing the tack conditions of small heat input to be output in the tack welding, the first layer condition to be output in the first layer penetration welding, the plurality of lamination conditions to be output in the first lamination welding step 41 for the lamination welding to the specific lamination bead height, and then the plurality of lamination conditions to be output in the second lamination welding step 42 for the lamination welding to the final layer at the top of the groove. A welding data file or another means having the function corresponding to the welding condition adjusting means may be used. Operation pendant 9b also serves as a welding performing means to allow the sequential execution of lamination welding 41 in the first lamination welding step including the tack welding and the first layer penetration welding and lamination welding 42 in the second lamination welding step based on each welding condition for each layer or each pas preset in the welding condition adjusting means or the welding data file corresponding to the welding condition adjusting means.

A first camera 35 for monitoring the welding state on the front side is placed on welding vehicle 4 between welding torch 7 and wire holder 25 above them. Video of the welding state on the front side taken by the first camera 35 and a camera controller 36 as a pair can be displayed on the first video monitor 37 for monitoring. Alternatively, it is possible to use another first video means and another first video display means corresponding to the first camera 35 and the first video monitor 37, respectively. As shown a lower portion of FIG. 8, the screen of the first video monitor 37 shows the electrode 6 and the wire 5 inserted into the groove 3 from the grove front sides 1a, 2a, arc 10 and molten pool 18 on the front side, and a molten pool 39 on the front side formed behind molten pool 18 and electrode 6. The position of the electrode 6 or the positions of the electrode and the wire 5 can be adjusted or controlled on the basis of the monitoring results of the welding state on the front side displayed on the screen of the first video monitor 37 to eliminate displacement of electrode 6 (for example, displacement of the electrode in the horizontal direction) or displacement of wire 5 (for example, displacement of the wire in horizontal and vertical directions). In addition, the factors of the welding condition can be adjusted or controlled.

In Embodiment shown in FIG. 6, the welding torch 7 mounted on the welding vehicle 4 is moved with the joint members 1 and 2 positioned and fixed. However, welded joint members 1 and 2 may be moved for welding with welding torch 7 stopped.

As shown in FIGS. 1, 2, and 3, in the second lamination welding step 42 for lamination welding to the bead cross section 30 in the final layer at the top of the groove, nickel-base alloy wire 57 different from the austenitic stainless steel wire 56 is supplied to and melted at the spot for arc welding in the groove to perform the lamination welding with one pass for each layer from the remaining welding portion 26 in groove 3 to bead cross section 30 in the final layer. The lamination welding can be performed with two passes for each layer in the respective parts of the grove on the left and right in the process of lamination with one pass for each layer, or the lamination welding can be performed with three or more passes for the final layer. The second lamination welding step 42 performed over the first weld metal 411 in this manner can reliably provide the second weld metal 422 with the different material as described above.

In addition, the second lamination welding step 42 using the nickel-base alloy wire is performed by using the welding condition used at the final phase in the first lamination welding step 41 using the austenitic stainless steel wire 56 before the second lamination welding step 42, or by changing into the proper welding condition including a smaller heat input than that in the condition before that final condition. This can achieve the favorable welding of the second weld metal 422 different from the first weld metal 411 to the top of the groove and reduce the contractive deformation or bending deformation due to the welding and the area affected by the heat. The welding can be performed by using again the final welding condition or the proper welding condition equivalent to the condition before the final condition to laminate the second weld metal 422 different from the first weld metal 411 to the top of the groove with a small number of passes. Bead cross section 30 in the final layer (P=N) is formed to be raised a little from the groove fronts la and 2a (for example, an excessive thickness of approximately 1 mm). In particular, for bead cross section 30 in the final layer or the layer before the final layer and bead cross section 30 in the final layer, it is preferable to perform weaving welding in which the welding torch 7 is shaken. The weaving welding can provide favorable penetration at both toes of the welding bead to provide an excellent welding bead appearance having waves like shells.

In this manner, the first lamination welding step 41 and the second lamination welding step 42 are performed to provide the first weld metal 411 and the second weld metal 422 with the two types of wire separately used for the respective steps to achieve the favorable welding results with no defect from the bottom to the top of the groove. Because of the material of the piping and the linear expansion coefficient of the second weld metal 422 smaller than that of the austenitic stainless steel wire forming the first weld metal 411, weld metal 422 involves less contraction at solidification than that of the first weld metal 411, so that the contraction in the circumferential direction of the piping (the tawarajime contraction) is suppressed, and the tensile stress remaining at the back of the weld on the groove bottom side and the proximity thereof can be reduced or changed into compressive stress. Simultaneously, the tensile stress remaining at the front of the weld in the final layer and the proximity thereof can be significantly reduced. In addition, the use of the welding condition including a reduced heat input for each welding pass can reduce the contractive deformation or bending deformation in the weld metal and the periphery due to the welding for each pass and the cumulative lamination welding and the area affected by the heat.

It should be further understood by those skilled in the art that although the foregoing description has been made on embodiments of the invention, the invention is not limited thereto and various changes and modifications may be made without departing from the spirit of the invention and the scope of the appended claims.

### ADVANTAGES OF THE INVENTION

According to the welding process for stainless steel piping of the present invention, the residual stress in the tensile direction at the weld on the inner side of the piping in contact with the reactor water can be improved. As a result, it is not necessary to provide an expensive heat treatment apparatus for removing the residual stress after the welding or to perform heat treatment, and thus the cost can be reduced. In addition, the present invention can contribute to prevention of stress corrosion cracking and a longer life of components of a nuclear power plant.

1. A welding process for stainless steel piping of performing welding from the bottom to the top of a groove using a filler, the groove being formed between opposed austenitic stainless steel pipes by mutually butting each groove of the austenitic stainless steel pipes comprising:
a first welding step of performing lamination welding of an austenitic stainless steel filler to a predetermined cumulative lamination bead height in the groove; and
a second welding step of performing lamination welding of a nickel-base alloy filler in the remaining portion in the groove after the first welding step.

2. A welding process for stainless steel piping of performing pulsed arc welding with a non-consumable electrode using welding wire from the bottom to the top of a groove, the groove being formed between austenitic stainless steel pipes by mutually butting each groove of the austenitic stainless steel pipes, comprising:
a manufacturing step of forming the groove of the pipes to be welded into a shape having dimensions in a predetermined range;
at least one of a first layer penetration welding step of forming a back bead having a predetermined width on the back side at the bottom of the groove or a tack welding step;
a first lamination welding step of performing lamination welding of austenitic stainless steel wire from the back to a predetermined cumulative lamination bead height of the groove; and
a second lamination welding step of performing lamination welding of nickel-base alloy wire from the predetermined cumulative lamination bead height to a final layer at the top of the groove after the first lamination welding step.

3. A welding process for stainless steel piping according to claim 1, wherein weld metal made of the nickel-base alloy in the groove has a linear expansion coefficient smaller than that of weld metal made of the austenitic stainless steel in the groove.

4. A welding process for stainless steel piping according to claim 1, wherein the first lamination welding step includes lamination welding with one pass for each layer, and
the second lamination welding step includes lamination welding with one pass for each layer, lamination welding with two passes for each layer in the respective parts of the grove on the left and right in the process of the lamination with one pass for each layer, and lamination welding with three or more passes for the final layer.

5. A welding process for stainless steel piping according to claim 1, wherein the groove of the pipes has a groove width at the bottom of the groove of 4 mm or larger to 8 mm or smaller and a side groove wall angle to the top of the groove of 10 degrees or less.

6. A welding process for stainless steel piping according to claim 1, wherein the cumulative lamination bead height is ⅕ or larger and ⅘ or smaller of the thickness of the pipe.

7. A boiling water reactor including components made of austenitic stainless steel, a weld of primary cooling water piping of the reactor being subjected to lamination welding from the bottom to the top of a groove using two types of welding wire, comprising:
a first layer penetration weld portion having a predetermined back bead width on the back side at the bottom of the groove;
a first weld metal portion provided by lamination welding of austenitic stainless steel wire from the back of the groove to a predetermined cumulative lamination bead height; and
a second weld metal portion in contact with the first weld metal and provided by lamination welding of nickel-base alloy wire from the predetermined cumulative lamination bead height to the top of the groove.

8. A boiling water reactor according to claim 7, wherein the second weld metal portion is YNiCr-3 or YNiCrMo-3.

9. A boiling water reactor according to claim 7, wherein the weld of the primary cooling water piping of the reactor has a residual stress of 100 MPa or smaller in a tensile direction at the back side of the weld.
